(19) United States
(12) Patent Application Publication
(10) Pub. No.: US 2014/0116356 A1
(43) Pub. Date: May 1, 2014

(54) Animal Collar Cover

(71) Applicant: Amy Balenzano, Spokane, WA (US)

(72) Inventor: Amy Balenzano, Spokane, WA (US)

(21) Appl. No.: 14/026,399

(22) Filed: Sep. 13, 2013

Related U.S. Application Data
(60) Provisional application No. 61/719,057, filed on Oct. 26, 2012.

(51) Int. Cl. A01K 29/00; B65D 65/08; A01K 27/00

(52) U.S. Cl. CPC A01K 29/00; A01K 27/001; B65D 65/08
USPC 119/858; 428/35.2

(57) ABSTRACT

The subject matter disclosed and claimed herein, in one aspect thereof, is an improved animal collar cover that is useful for shielding an animal collar from dirt, grime, and the elements, and that is also at least partially comprised of a reflective material, thereby making the animal and/or its handler much easier to see at nighttime or in dimly lit areas. In a preferred embodiment of the present invention, the improved animal collar cover also allows an animal owner and/or handler to express the animal and/or the handler's personality or style sense, and is relatively inexpensive to manufacture and easy to install on an existing animal collar.

### CROSS-REFERENCE

This application claims priority from Provisional Patent Application Ser. No. 61/719,057 filed on Oct. 26, 2012.

### FIELD OF THE INVENTION

This invention relates to an improved animal collar cover. The unique design of the improved animal collar cover of the present invention not only protects the animal collar from the weather (e.g., rain, snow, sleet, etc.) but is also reflective thereby making the animal and/or its handler much easier to see at nighttime or in dimly lit areas.

### BACKGROUND

Many animal collars tend to become damaged over time from continued exposure to dirt, grime, weather and the elements (e.g., rain, snow, sleet, etc.). Once damaged, the appearance of the collar may no longer be acceptable and/or the collar may fail, and need to be replaced. Having to continue to replace animal collars can be both time consuming and expensive.

Other animal colors are typically constructed of non-reflective material. The lack of a reflective material on an animal collar can make it difficult for others, such as a driver of oncoming vehicle, to see the animal and/or the animal's handlers at nighttime or in dimly lit areas, which can be dangerous for all parties involved. Still other animal collars are plain and/or without design, and do not permit the animal handler to express the animal and/or the handler's personality or style sense.

Consequently, there exists in the art a long-felt need for an improved animal collar cover that protects the animal collar from dirt, grime, weather and the elements (e.g., rain, snow, sleet, etc.). There also exists in the art a long felt need for an improved animal collar cover that is reflective, thereby making the animal and/or its handler much easier to see at nighttime or in dimly lit areas. Additionally, there is a need in the art for an animal collar cover that allows an animal owner and/or handler to express the animal and/or the handler's personality or style sense. Finally, there is a long-felt need for an improved animal collar cover that accomplishes all of the forgoing objectives and that is relatively inexpensive to manufacture, and safe and easy to use.

### SUMMARY

The following presents a simplified summary in order to provide a basic understanding of some aspects of the disclosed innovation. This summary is not an extensive overview, and it is not intended to identify key/critical elements or to delineate the scope thereof. Its sole purpose is to present some concepts in a simplified form as a prelude to the more detailed description that is presented later.

The subject matter disclosed and claimed herein, in one aspect thereof, is an improved animal collar cover that: (a) protects the animal collar from dirt, grime, weather and the elements (e.g., rain, snow, sleet, etc.); (b) is at least partially comprised of a reflective material, thereby making the animal and/or its handler much easier to see at nighttime or in dimly lit areas; (c) allows an animal owner and/or handler to express the animal and/or the handler's personality or style sense; and (d) is relatively inexpensive to manufacture and easy to install on an existing animal collar. In a preferred embodiment of the present invention, the improved animal collar cover comprises a sleeve portion comprised of a first end, a second end, a continuous opening extending between said first end and said second end for receipt of a prior art animal color, an outer surface wherein at least a portion of said outer surface is comprised of a reflective material, and a fastener for temporarily joining said first end to said second end.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and is intended to include all such aspects and their equivalents. Other advantages and novel features will become apparent from the following detailed description when considered in conjunction with the drawings.

### BRIEF DESCRIPTION OF THE DRAWINGS

FIG. 1 illustrates a perspective view of a preferred embodiment of the improved animal collar cover of the present invention.

FIG. 2 illustrates a perspective view of a preferred embodiment of the closure system of the improved animal collar cover of the present invention.

FIG. 3 illustrates a perspective view of a preferred embodiment of the improved animal collar cover of the present invention installed on a prior art animal collar.

FIG. 4 illustrates a perspective view of a preferred embodiment of the improved animal collar cover of the present invention installed on a prior art animal collar, which is being worn by a dog.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details.

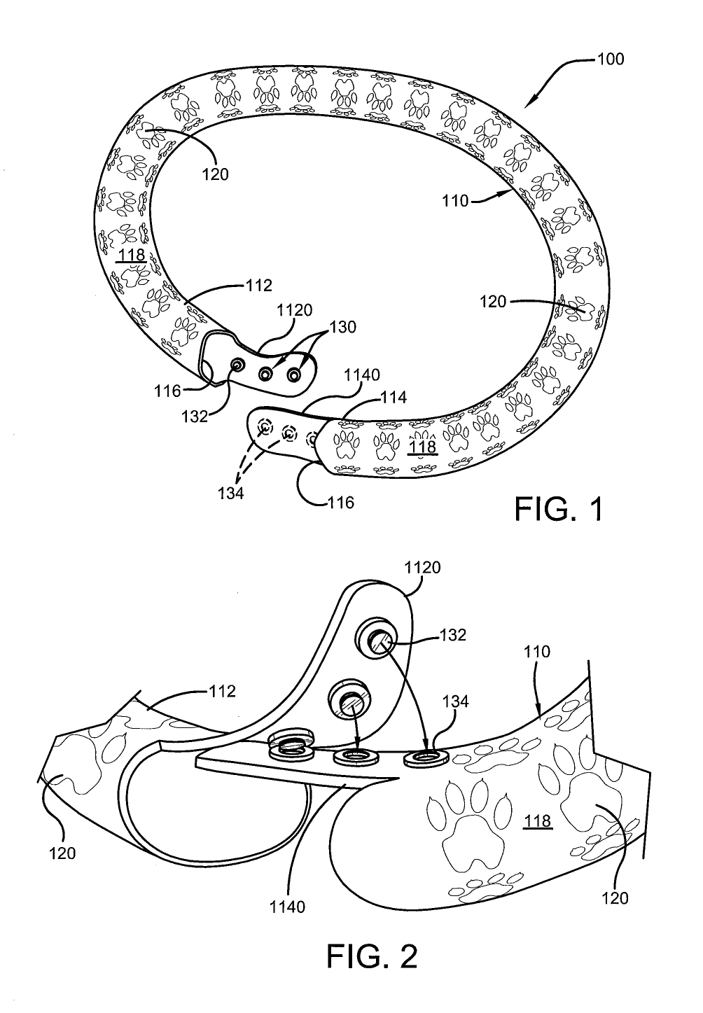

Referring initially to the drawings, FIG. 1 illustrates a perspective view of a preferred embodiment of the improved animal collar cover 100 of the present invention. Cover 100 is preferably comprised of a sleeve portion 110 and a fastener 130. Sleeve portion 100 is preferably an elongated member comprised of a first end 112, a second end 114, a continuous opening 116 therein and extending between said first end 112 and said second end 114, and an outer surface 118. Unless otherwise described herein the various components of cover 100 are preferably comprised of plastic, cotton, nylon, velvet, etc., though it is contemplated that other materials could also be used provided that at least a portion of said materials is reflective of light, as described more fully below.

In a preferred embodiment of the present invention, first end 112 further comprises a first flap 1120 and said second end 114 further comprises a second flap 1140. Fastener 130 is used to removably connect first flap 1120 of first end 112 to second flap 1140 of second end 114. Fastener 130 can be any type of fastener commonly known in the art for removably connecting two sections or straps together such as hook and loop fasteners, buttons, clasps, buckles, etc. However, in a preferred embodiment of the present invention, fasteners 130 are preferably a snap fastener with a male portion 132 and a corresponding female portion 134. More specifically, one or more of male portions 132 are attached to first strap 1120 and corresponding female portions 134 are attached to second strap 1140 for mating engagement with male portions 132, as best illustrated in FIG. 2, or vice versa. One of ordinary skill in the art should appreciate that by including multiple fasteners 130, cover 100 can accommodate many different sizes of collar 200. Fastener 130 is preferably positioned between prior art collar 200 and the animal 300 wearing the collar 200 so as to not conceal an animal identification tag 210, as shown in the attached FIGS.

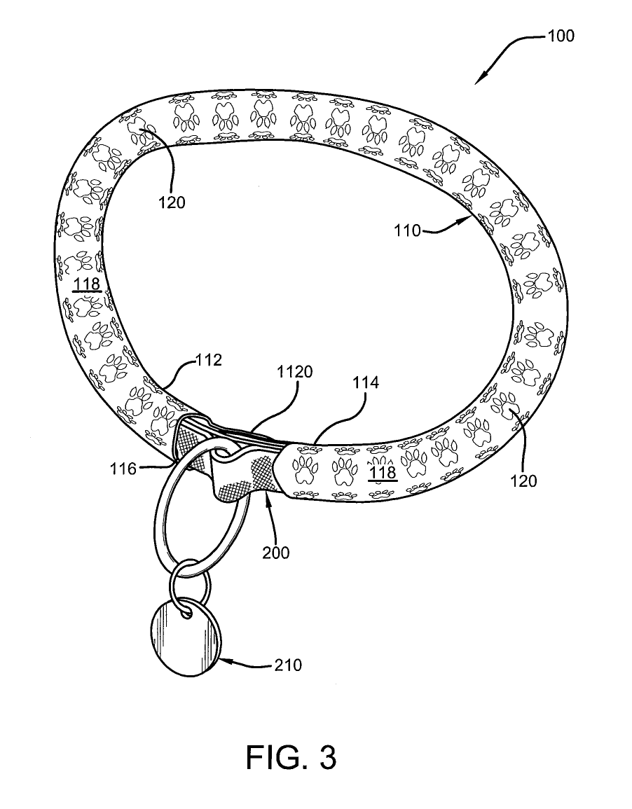

As previously stated, cover 110 has many functions, one of which is to protect a prior art animal collar 200 from dirt, grime, weather and the elements (e.g., rain, snow, sleet, etc.). More specifically, one end of a prior art animal collar 200 may be inserted into continuous opening 116 of cover 110 such that, when properly installed, cover 110 substantially encompasses animal collar 110 and protects the same from wear and tear, as shown in FIG. 3. While cover 100 may come in a variety of shapes and sizes to suit user need and/or preferences, to accommodate most sizes of animal collars 200, sleeve portion 110 is preferably between six and twenty inches in length, as measured from first flap 1120 to second flap 1140, and the diameter of continuous opening 116 is preferably between ⅝ths of an inch and four inches. Nonetheless, as previously stated, other dimensions could also be used provided that cover 100 substantially covers prior art animal collar 200.

Additionally, cover 110 is also designed to increase the visibility of the animal wearing cover 110 and/or the animal handler. More specifically, at least a portion of the outer surface 118 of sleeve portion 110 is preferably comprised of a light reflective or glow in the dark material 120. Said materials are well known in the art and readily available at many craft and department stores. In a preferred embodiment of the present invention, more than 10% of the total surface area of outer surface 118 is comprised of reflective material 120. Reflective material 120 may be printed on, or applied to, outer surface 118 in the form of a repeatable pattern, as shown in the FIGS., or it may be incorporated into cover 100 in the form of piping or any other method or process known for incorporating a reflective material into the outer surface or an object to increase invisibility of said object.

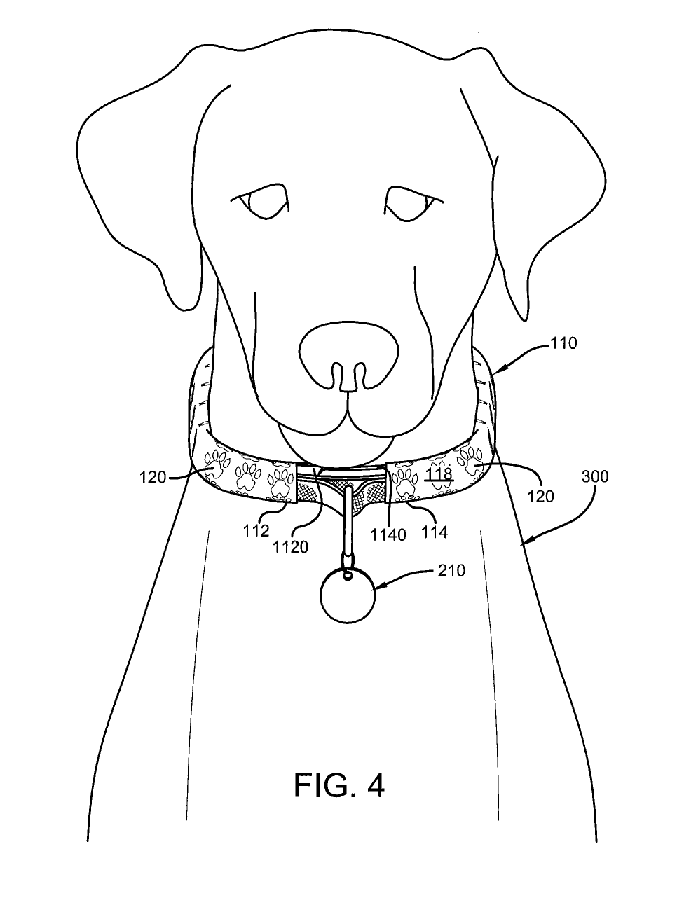

Having described the overall structure of improved cover 100, the installation and usefulness of the same will now be summarized. A user (not shown) desiring to protect an animal collar 200 from dirt, grime, weather and the elements, while also improving the visibility of the animal 300 at nighttime or in dimly lit areas, would simply insert one end of collar 200 into continuous opening 116 so that the cover 100 substantially encompasses or covers collar 200 and animal tag 210 is exposed to viewing, as best shown in FIG. 4. Once cover 100 is properly positioned along collar 200, the user may temporarily secure cover 100 to collar 200 with fastener 130. More specifically, if a snap fastener is employed, the user (not shown) would simply matingly engage one of more of male portions 132 with its corresponding female portion 134, which will also reduce the likelihood that cover 100 will slide along collar 200 when the animal is in motion. When a user desires to remove collar 200 and cover 100 from animal 300 (e.g., to clean or replace collar 200 or cover 100), the user would simply disengage male portions 132 from female portion 134 and remove collar 200 from cover 100. Furthermore, because cover 100 is relatively inexpensive to manufacture and can be easily installed and/or removed from collar 200, a user can possess many covers 100 of different colors, designs, and/or shapes and apply said covers 100 to collar 200 as a means of expressing the mood or personality of the animal wearing the cover 100 or the user.

Consequently, the various embodiments of the improved animal collar cover 100 of the present invention described herein are useful for shielding the animal collar from dirt, grime, weather and the elements, and are at least partially comprised of a reflective material, thereby making the animal and/or its handler much easier to see at nighttime or in dimly lit areas. Furthermore, the improved animal collar cover 100 of the present invention allows an animal owner and/or handler to express the animal and/or the handler's personality or style sense, and is relatively inexpensive to manufacture and easy to install on an existing animal collar.

Other variations are within the spirit of the present invention. Thus, while the invention is susceptible to various modifications and alternative constructions, a certain illustrated embodiment thereof is shown in the drawings and has been described above in detail. It should be understood, however, that there is no intention to limit the invention to the specific form or forms disclosed, but on the contrary, the intention is to cover all modifications, alternative constructions, and equivalents falling within the spirit and scope of the invention, as defined in the appended claims.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate embodiments of the invention and does not pose a limitation on the scope of the invention unless otherwise claimed. No language in the specification should be construed as indicating any non-claimed element as essential to the practice of the invention.

Preferred embodiments of this invention are described herein. Variations of those preferred embodiments may become apparent to those of ordinary skill in the art upon reading the foregoing description. The inventor expects skilled artisans to employ such variations as appropriate, and the inventor intends for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A cover for an animal collar comprising:
a sleeve portion comprised of a first end, a second end, a continuous opening in said sleeve portion extending between said first end and said second end for receipt of the animal collar, and an outer surface; and
a fastener for temporarily joining said first end to said second end.

2. The cover of claim 1 wherein at least a portion of said outer surface is comprised of a reflective material.

3. The cover of claim 2 wherein said reflective material is in the form of a repeatable pattern.

4. The cover of claim 2 wherein said reflective material is in the form of piping.

5. The cover of claim 1 wherein said first end further comprises a first flap and said second end further comprises a second flap.

6. The cover of claim 1 wherein said first end further comprises a first flap and said second end further comprises a second flap.

7. The cover of claim 1 wherein said animal collar further supports an identification tag and said cover does not conceal the identification tag.

8. The cover of claim 1 wherein said fastener is a snap fastener.

9. The cover of claim 1 wherein said fastener is a hook and loop fastener.

10. The cover of claim 1 wherein more than 10% of a total surface area of the outer surface is comprised of a reflective material.

11. A cover for an animal collar comprising:
a sleeve portion comprised of an opening therein for receipt of the animal collar and an outer surface; and
a fastener.

12. The cover of claim 11 wherein more than 10% of a total surface area of the outer surface is comprised of a reflective material.

13. The cover of claim 11 wherein at least a portion of said outer surface is comprised of a reflective material.

14. The cover of claim 13 wherein said reflective material is in the form of a repeatable pattern.

15. The cover of claim 13 wherein said reflective material is in the form of piping.

16. The cover of claim 11 wherein said animal collar further supports an identification tag and said cover does not conceal the identification tag.

17. The cover of claim 11 wherein said fastener is a snap fastener.

18. The cover of claim 11 wherein said fastener is a hook and loop fastener.

19. A cover for an animal collar comprising:
a sleeve portion comprised of a first end, a second end, a continuous opening in said sleeve portion extending between said first end and said second end for receipt of the animal collar, and an outer surface, wherein more than 10% of a total surface area of said outer surface is comprised of a reflective material; and
a fastener for temporarily joining said first end to said second end.

20. The cover of claim 19 wherein said fastener is a plurality of snap fasteners.
